(19) United States
(12) Patent Application Publication
(10) Pub. No.: US 2025/0124608 A1
(43) Pub. Date: Apr. 17, 2025

(54) SYSTEM AND METHOD FOR IMAGE COMPRESSION BASED ON MACHINE LEARNING

(71) Applicants: OMAR AHMAD ABDO AL TAMIMI, Amman (JO); Tareq Aljaber, Brentwood, CA (US)

(72) Inventors: OMAR AHMAD ABDO AL TAMIMI, Amman (JO); Tareq Aljaber, Brentwood, CA (US)

(21) Appl. No.: 19/001,529

(22) Filed: Dec. 25, 2024

Related U.S. Application Data
(63) Continuation-in-part of application No. 17/571,538, filed on Jan. 10, 2022, now Pat. No. 12,217,467.
(60) Provisional application No. 63/135,552, filed on Jan. 8, 2021.

(51) Int. Cl. G06T 9/00

(52) U.S. Cl. CPC G06T 9/002

(57) ABSTRACT

A system and method for compressing and decompressing image data, which provides better compression and minimal representation of the input image with minimal loss compared to previous Deep Learning codecs. The system can provide quantization during training, flexible addition of filters, and conditional complexity of image compression. The Deep Learning codec generates codes that are directly usable with Machine Learning algorithms, thus boosting the performance of Machine Learning algorithms.

### CROSS-REFERENCE TO RELATED APPLICATIONS

This application is a continuation in part of a U.S. patent application Ser. No. 17/571,538 filed on Jan. 10, 2022, which claims priority from a U.S. Provisional Patent Appl. No. 63/135,552, filed on Jan. 8, 2021, both of which are incorporated herein by reference in its entirety.

### FIELD OF INVENTION

The present invention relates to a system and method for image data processing and video data compression, and more particularly, the present invention relates to a novel quantized auto-encoder neural network system and methods, and three-dimensional convolution neural networks and established video codecs.

### BACKGROUND

Reducing an image's size with high fidelity has long been a major challenge in the image processing industry. Data compression is critically important in the field of data science. Image data compression algorithms that can be more efficient and deliver higher fidelity than the existing solutions are of great interest and commercial value. Applying machine learning to big data requires efficient data compression methods to reduce storage and processing time. However, the compression of the image data requires reconstruction of the images, and the reconstruction process is lossy. In lossy image compression, information is deliberately discarded to decrease the storage space of images and videos. Any quality degradation of images may negatively affect the machine learning model's performance.

Feng Jiang et al., IEEE, Transactions on circuits and systems for video technology, Aug. 2, 2017, teaches the application of Deep Learning to image compression even though image compression is seen as a low-level problem for Deep Learning. They also report that, unfortunately, the rounding function in quantization is not differentiable, which brings great challenges to training deep neural networks when performing the backpropagation algorithm. However, those models still have problems and challenges: Since the quantization process is undifferentiable, the known models do not allow for gradient flow through the quantization process. This issue hindered the training process described in the said references, and it required further adjustments to the solutions described. The added adjustments required more training time, longer processing, and fidelity loss.

Another, Yunjin Chen et al., Trainable Nonlinear Reaction Diffusion: A Flexible Framework for Fast and Effective Image Restoration, IEEE transactions on pattern analysis and machine intelligence, VOL. 39, Issue. 6, 2016, describes a flexible learning framework based on the concept of nonlinear reaction-diffusion models for various image restoration problems. Chen acknowledged that it is generally hard to train a universal diffusion model to handle all the noise levels or all upscaling factors.

Beyond image compression, video compression also presents additional challenges due to temporal redundancy and motion estimation requirements. Current neural video codecs like DCVC-DC achieve high compression ratios but require significant computational resources for training and inference. Additionally, these fully neural approaches often struggle with generalization across different video content types and motion patterns. While neural video compression models have shown promise, they frequently reinvent established temporal compression techniques rather than leveraging proven video codec technologies.

Thus, there exists an industry in need of novel methods of image data compression with high fidelity. Also, there remains an industry need for efficient video compression methods that combine the benefits of traditional video codecs with neural network preprocessing and postprocessing capabilities.

### SUMMARY OF INVENTION

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a machine learning-based system and method for image data compression with high fidelity.

Another object of the present invention is that the disclosed system and method can handle a large volume of image data efficiently.

Still, another object of the present invention is that the system and method can provide faster and greater compression for images and videos with minimal loss in quality.

Yet another object of the present invention is greater generalization compared to conventional deep-learning codecs.

A further object of the present invention is that the codes could be directly usable with machine learning algorithms thus boosting the performance of Machine Learning algorithms.

In one aspect, disclosed is a system and method for compressing and decompressing image data with high fidelity. For example, the compression format may be JPEG 2000, which boasts a structural similarity index measure (SSIM) of 77%, indicating a relatively low fidelity or lossy transformation, while reducing the input at a ratio of 16:1.

In one implementation, disclosed is a Deep Learning codec that provides better compression and minimal representation of the input image with minimal loss. The Deep Learning codec also returns codes that are directly usable with Machine Learning algorithms, thus boosting the performance of Machine Learning algorithms. The reduced representations by the disclosed Deep Learning codec are compatible with Deep Learning, such that one can directly use the minimized representations generated by this codec to train a model without having to decompress the minimized representations. This capability can reduce the overall size of the network, reduce the duration of the training time, and increase the generality of the Network. These minimized representations also retain spatial information due to the method and nature of the compression.

In one aspect, the codec model's architecture may naturally extend to video compression through the replacement of two-dimensional convolutions with three-dimensional convolutions, enabling the network to learn spatio-temporal features. When combined with established video codecs like MPEG-4, the system achieves superior compression ratios while maintaining high fidelity.

In video compression implementations, the disclosed system may achieve a theoretical compression ratio of (2×8\hat{ }n):1, where “n” represents the number of compression blocks, reflecting the additional temporal dimension of compression. The quality of the compressed video is evaluated using the Multi-Scale Structural Similarity Index Measure (MS-SSIM), providing a more comprehensive assessment of perceived video quality.

In one implementation, Greedy Training, also known as Greedy layer-wise pretraining, can provide a way to develop deep multilayered neural networks. Pretraining can be used to iteratively deepen a supervised model or an unsupervised model that can be repurposed as a supervised model. The disclosed codec model can allow users to discover certain metrics within their datasets, such as the complexity of each image or the complexity of a certain region within an image. The values of these metrics can predict the regions in an image that will incur the most losses when reconstructing the image.

The Greedy Training aspect of the instant invention allows greater compression than previous methods. In the Greedy Training method, according to the present invention, the number of filters may not be fixed. For a simple data set of grayscale binary images, for example, a black image with one dot, the best representation of this image would simply be the coordinates of the dot. Other systems will compress that image to a limit. On the other hand, the disclosed encoder network grows, so the compression ratio also grows depending on the performance. As the network grows, the number of filters grows, and the compression ratio grows two-fold. With a single filter, the disclosed model can have a compression ratio of 32:1, and with two filters, the model can have a compression ratio (16×2ⁿ):1, where n is the number of filters i.e., an exponential growth.

### BRIEF DESCRIPTION OF THE DRAWINGS

The accompanying figures, which are incorporated herein, form part of the specification and illustrate embodiments of the present invention. Together with the description, the figures further explain the principles of the present invention and enable a person skilled in the relevant arts to make and use the invention.

FIG. 1 is a block diagram showing the architecture of the system, according to an exemplary embodiment of the present invention.

FIG. 2 is a diagram illustrating an implementation of the disclosed system and method, showing the three modules of the encoder and the major elements of each module, according to an exemplary embodiment of the present invention.

FIG. 3 is a diagram of the encoder network with its automatic expansion capabilities visualized, according to an exemplary embodiment of the present invention.

FIG. 4 is a diagram illustrating the Bottleneck network, according to an exemplary embodiment of the present invention.

FIG. 5 is a diagram illustrating the Decoder network including details of the Residual Building Blocks module, according to an exemplary embodiment of the present invention.

FIG. 6 is a table showing the results of a PSNR comparison between the performance of the disclosed model with the performance of a known model.

FIG. 7 is a table showing the results of an SSIM comparison between the performance of the disclosed model with the performance of a conventional model.

FIG. 8 is a diagram illustrating the modified encoder architecture for video compression, showing the Conv3D filters and three-dimensional compression blocks, according to an exemplary embodiment of the present invention.

FIG. 9 is a diagram showing a bottleneck network adapted for video compression with integrated MPEG-4 codec components, according to an exemplary embodiment of the present invention.

FIG. 10 is a diagram demonstrating the decoder network architecture for video compression with three-dimensional forward blocks and up-sampling operations, according to an exemplary embodiment of the present invention.

FIG. 11 is a table showing the results of Compression Rate (%), BD Rate (%) with MS-SSIM, and PSNR comparisons between the performance of the disclosed model with other video compression methods, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely to illustrate the general principles of the invention since the scope of the invention will be best defined by the allowed claims of any resulting patent.

The described features, structures, or characteristics of the invention may be combined in any suitable manner in accordance with the aspects and one or more embodiments of the invention. In the following description, numerous specific details are recited to provide an understanding of various embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

Disclosed are a system and a method for overcoming the drawbacks and challenges with the known image compression codecs by providing a codec that reduces the dimensionality of the input images while retaining spatial information. Disclosed is a deep-learning codec that can apply a quantization operation during the training process.

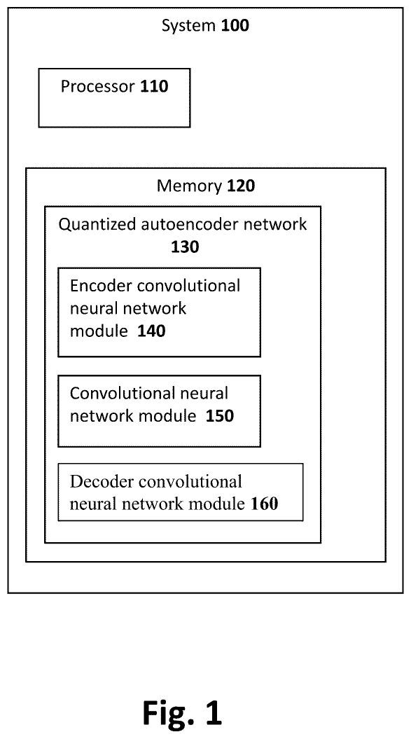

Referring to FIG. 1, which is a block diagram showing an exemplary embodiment of the disclosed system 100. The system 100 may include a processor 110 and a memory 120 connected through a system bus (not shown). The processor 110 can be any logic circuitry that responds to, and processes instructions fetched from the memory 120. The processor can read instructions from a machine-readable or computer-readable medium (e.g., a non-transitory machine-readable storage medium) and perform one or more of the methodologies discussed herein. The memory 120 may include one or more memory chips capable of storing data and allowing any storage location to be directly accessed by the processor 110. The memory 120 may include modules that upon execution by the processor can perform one or more of the methodologies discussed herein.

The term module as used herein and throughout this disclosure refers to software, a program code, a set of rules or instructions, and the like in one or more computer-readable languages including graphics, which upon execution by the processor performs one or more steps of the disclosed methodology. Also, operations may be described as a sequential process, some of the operations may be performed in parallel, concurrently, and/or in a distributed environment, and with program code stored locally or remotely for access by single or multi-processor machines. In addition, in some implementations, the order of operations may be rearranged without departing from the spirit of the disclosed subject matter.

The memory 120 may include a Quantized autoencoder network 130 which upon execution by the processor can provide for compression and decompression of image data with high fidelity. The Quantized autoencoder network 130, also referred to herein as the codec, can include three essential modules: the encoder convolutional neural network module 140 (the encoder network), the intermediate convolutional neural network module 150 (the bottleneck network), and the decoder convolutional neural network module 160 (the decoder network).

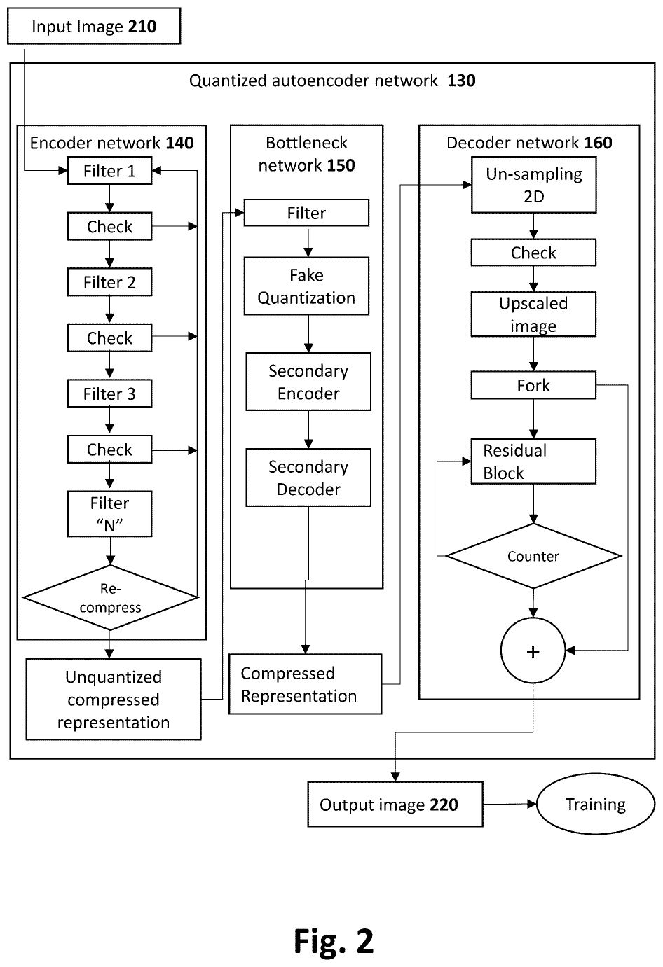

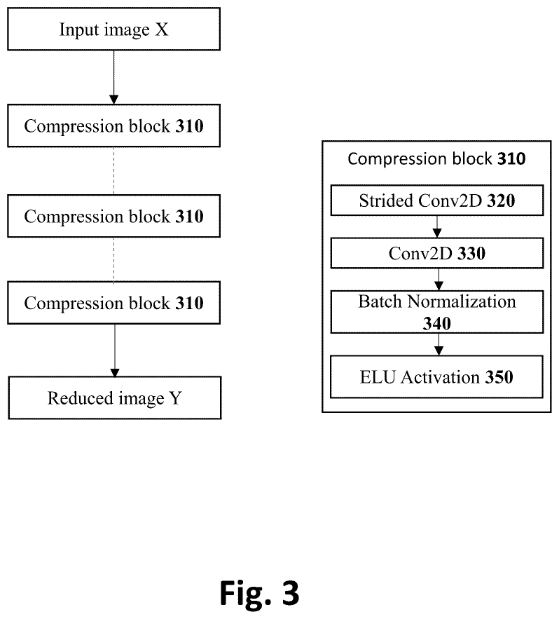

Referring to FIG. 2 which is a block diagram illustrating the methodology disclosed herein. The input image 210 can be compressed to the output image 220 by the execution of the Quantized autoencoder network 130. The Encoder convolutional neural network module 140 can reduce the dimensions of the input image 210 through learned filters. An implementation of the Encoder convolutional neural network module 140 is shown in FIG. 3. FIG. 3 is a flowchart showing the input image X that can be compressed multiple times by passing through the compression blocks. The Encoder convolutional neural network module 140 upon execution by the processor can feed the input image data into the compression block 310 of the encoder 140 where a series of filters can be applied to the original image. In one implementation, compression block 310 can include filters such as Strides Conv2D 320, Conv2D 330, Batch Normalization 340, and ELU Activation 350.

The most common type of convolution that can be used is the 2D convolution layer, abbreviated as conv2D. A filter or a kernel in a conv2D layer has a height and a width. These kernels are generally smaller than the input image, so they should be moved across the whole image. Conv2D is known in the art and Stride, in the convolution process, defines an overlap between applying operations. The strided Conv2d can specify if what is the distance between consecutive applications of convolutional filters. Batch normalization is a popular and effective technique that consistently accelerates the convergence of deep networks. The ELU filter or Exponential Linear Unit is a function that tends to converge cost to zero faster and produce more accurate results. Different from other activation functions, ELU has an extra alpha constant which should be a positive number. One novel aspect of using filters in the encoder module of this invention is that the filter configuration is flexible. FIG. 3 shows three consecutive blocks 310, however, the detailed structure of the encoder module may not be fixed but can grow throughout the training process. The compression ratio can increase fourfold for each growth stage. The growth of the encoder model 140 may also depend on the performance during training. If the model is capable of handling the current compression rate with sufficient accuracy and fidelity, then the model can be further strained by adding another compression block.

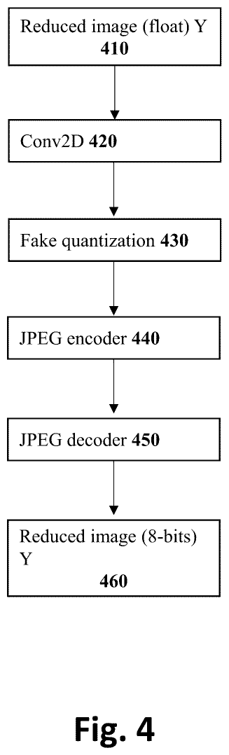

Again, referring to FIG. 2, the bottleneck module 150 can receive the encoder's output i.e., the unquantized compression representation of the input image data. The bottleneck module 150 upon execution by the processor can apply quantization with a custom gradient function to allow for gradient flow. Referring to FIG. 4, which illustrates the implementation of bottleneck module 150, a novel aspect of this invention is that the bottleneck network module utilizes fake quantization to allow quantization to occur during the training process. Fake quantization is a feature known in the art and commercially available. TensorFlow, which is a free and open-source software library for machine learning and artificial intelligence, utilizes a fake quantization module. The quantization using a fake quantization module allows for gradient flow through the quantization process. The criteria for when to add another compression block are part of the novelty of this invention. The specific compression blocks to add are yet another novel aspect of this invention. This reduced image can be further reduced via one or more traditional codecs such as OCT/JPEG 2000, or losslessly via the image file format PNG (Portable Network Graphics). The output of the bottleneck network is a reduced image representation of the input image data. FIG. 4 shows the reduced image (float) Y 410 which is the output of the encoder network and received by the bottleneck network 150, a Conv2D filter 420, a fake quantization module 430, a secondary encoder 440, a secondary decoder 450, and an output of the bottleneck network which is a quantized reduced image (8-bits) Y 460.

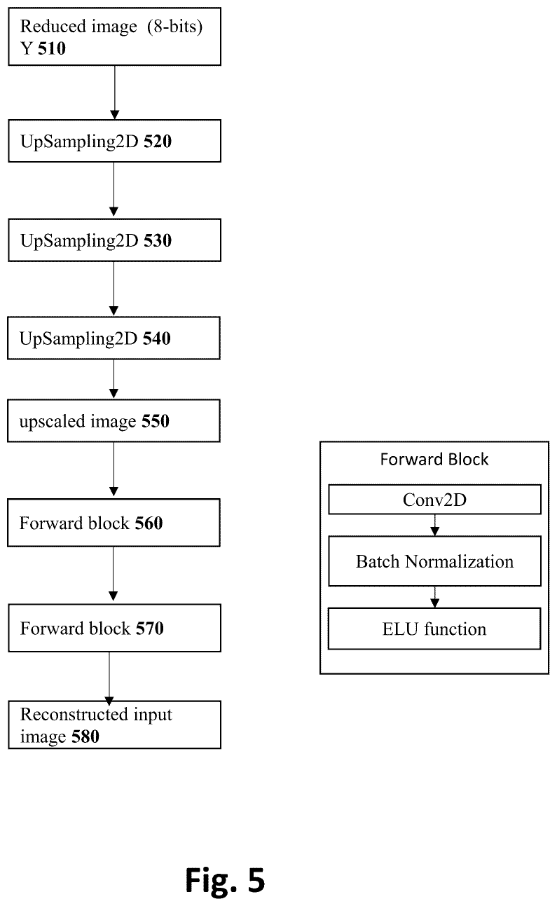

Again, refer to FIG. 2 which shows the decoder module 160 can receive the compressed quantized representation from the bottleneck network 150. The decoder network 160 can reconstruct the quantized compressed representation of the input image data. As shown in FIG. 5, which shows the implementation of the decoder network 160, the decoder network 160 can initially upscale the code image N times, where N is the current number of compression blocks. The upscaled image can then be fed through a residual network with a number of residual blocks. In one example, ten forward blocks can be in the residual network. The upscaled image forks at the start and is summed to the output of the last residual output, allowing for gradient flow to the encoder and bottleneck networks. This network effectively accounts for the JPEG (joint photographic experts group) compression losses and increases the quality of the output image. FIG. 5 shows the reduced image (8-bits) Y obtained from the bottleneck network, upSampling2D function 520, upSampling2D function 520, and upSampling2D function 540 all connected in series as shown in FIG. 5, upscaled image 550, forward block 560, forward block 570, and the reconstructed image 580. The forward block is also illustrated in FIG. 5 including the Conv2D filter, Batch normalization filter, and the ELU function.

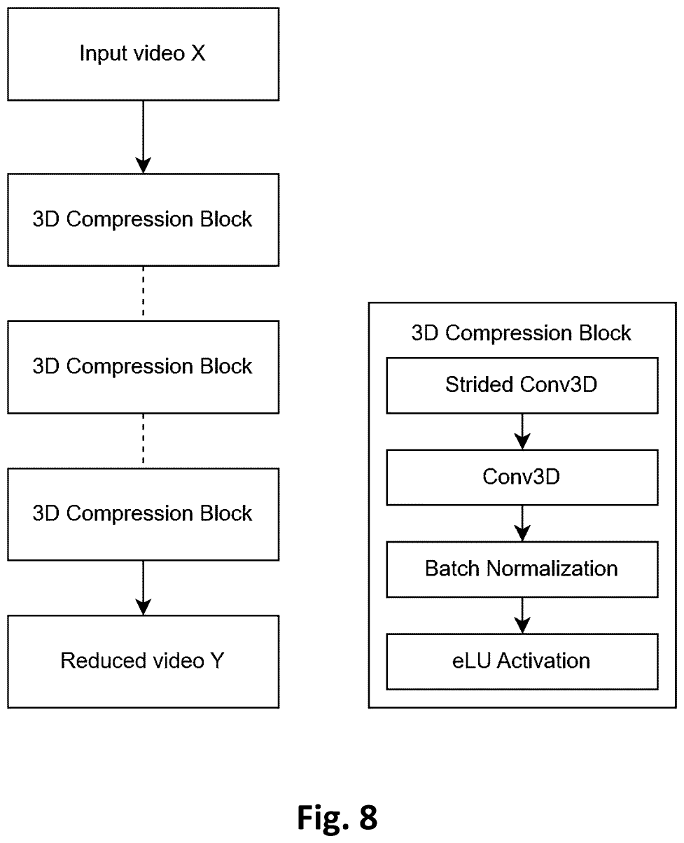

The disclosed system and method can be implemented for video compression by modifying the network architecture to process three-dimensional data. The encoder network's Conv2D filters may be replaced with Conv3D filters to capture both spatial and temporal features. Similarly, all two-dimensional operations in the compression blocks may be replaced with their three-dimensional counterparts, including Batch Normalization and striding operations. FIG. 8 illustrates the modified encoder architecture for video compression, showing the Conv3D filters and three-dimensional compression blocks. In video compression implementations, the bottleneck network utilizes MPEG-4 encoding and decoding instead of JPEG compression. This modification allows the disclosed network to leverage established video codec technology while maintaining the benefits of neural preprocessing and postprocessing. The fake quantization module remains functionally identical but may operate on three-dimensional tensors.

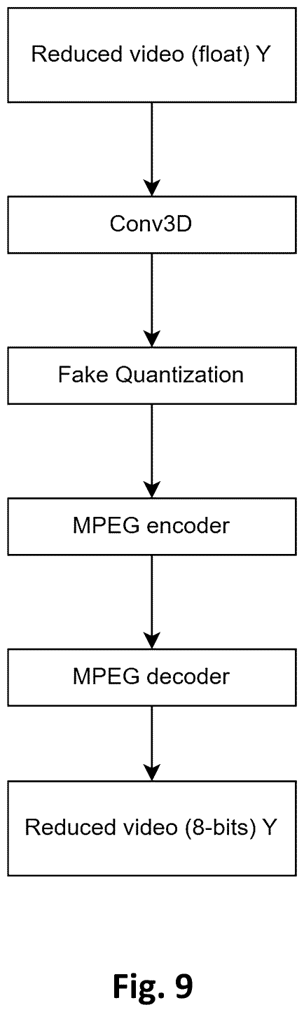

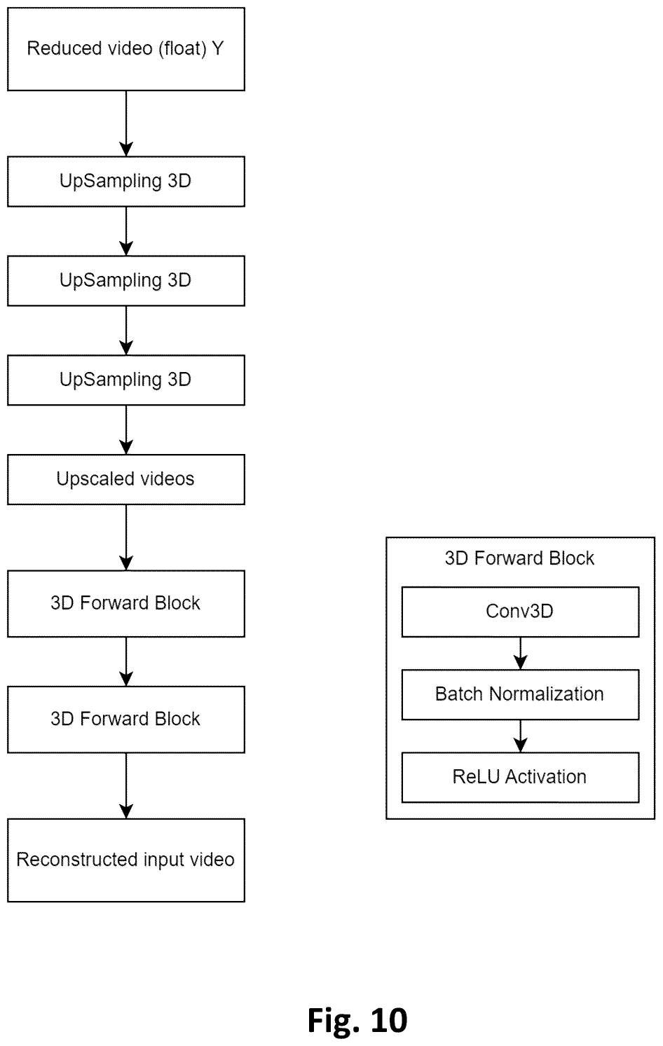

FIG. 9 shows the bottleneck network modified for video compression, illustrating the integration with MPEG-4 codec. The decoder network's architecture mirrors the dimensional changes of the encoder, employing three-dimensional up-sampling operations (UpSampling3D) and Conv3D filters in its forward blocks. The residual connections are maintained but operate on three-dimensional feature maps. The theoretical compression ratio in video implementations follows (2×8\hat{ }n):1, where n represents the number of compression blocks. This modified ratio reflects the additional compression achieved through temporal redundancy reduction. The system maintains its dynamic growth capability, adding compression blocks based on performance during training. FIG. 10 demonstrates the decoder network architecture for video compression, showing the three-dimensional forward blocks and up-sampling operations.

Greedy Training: The compression ratio of the model in this invention grows throughout the training process. By continuing to grow the compression ratio through the training process, no matter what the dataset that is used, the model can achieve a superior compression ratio with minimal losses in image quality and fidelity.

Composite Loss function: In the training phase, the following are the loss or objective functions to minimize:

$${L}_{reconstruction} = \frac{1}{N} \sum {( f ( x ) - x )}^{2} \\ and \\ {L}_{compression} = \frac{1}{N} \sum {( \hat{Y} - Q )}^{2} \\ Where the total loss of our Network is : \\ {L}_{total} = {L}_{reconstruction} + {L}_{compression}$$

Where “N” in both cases is the total number of data points in the squared term, this loss function is known as the mean squared error, and f (x) is the function representing the whole model, wherein “x” is the input image. The output of this function is the final reconstructed image. “Y” is the output of the bottleneck network, and “Q” is the input of the JPEG compression layer.

While the reconstruction loss is widely known in prior art, the disclosed codec includes the compression loss. By including compression loss, the encoder network can change the input image to better fit the JPEG compression algorithm thus reducing the losses caused by the compression.

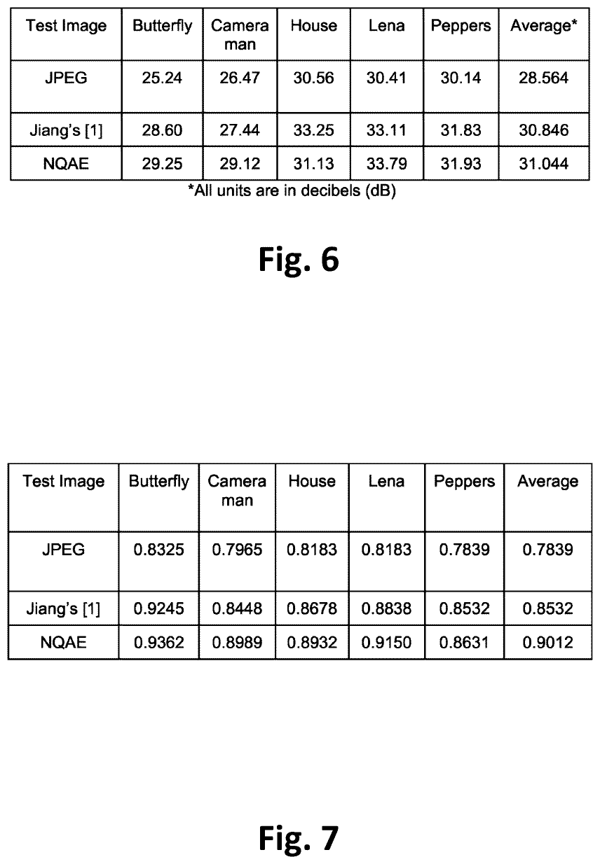

Advantages and benefits of the invention include speed and performance. The performance of the model which is the subject of this invention was tested on the same dataset as that of Feng Jiang, et al., An End-to-End Compression Framework Based on Convolutional Neural Networks, IEEE Transactions on Circuits and Systems for video technology, Aug. 2, 2017. This particular dataset is used as a benchmark for a majority of works in this field. Thus, the performance of the model which is the subject of this invention can be compared fairly with previous state-of-the-art solutions. The results of such a comparison are shown in FIG. 6. The model which is the subject of this invention is abbreviated as NQAE (Novel Quantized Auto Encoder). The known model is referred to as Jiang's. The performance of the NQAE model was significantly better than the previous state-of-the-art solution in comparison, as shown in FIG. 6. The comparison used the PSNR (Peak Signal to Noise Ratio) image quality metric. The performance of the NQAE model was substantially superior as measured by the structural similarity index metric, as shown in FIG. 7.

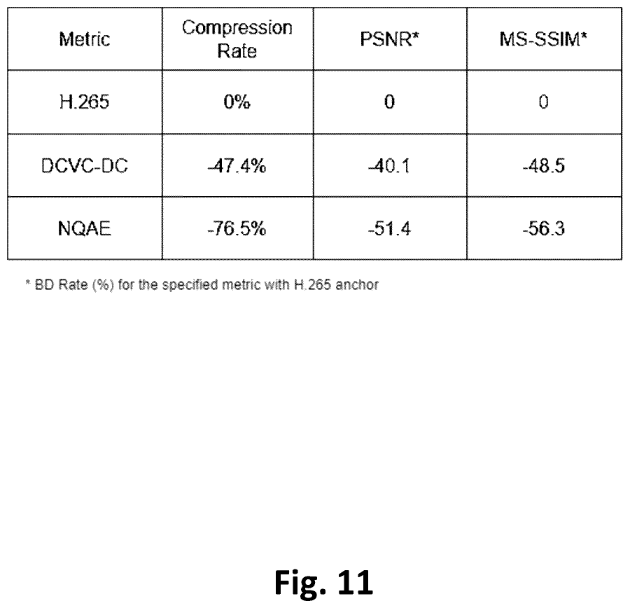

The performance of the video compression model was evaluated against DCVC-DC, a state-of-the-art neural video codec. Results demonstrate superior performance in compression efficiency while maintaining comparable or better-quality metrics. FIG. 11 shows the Compression Rate (%), which measures the percentage of decrease in storage size, BD Rate (%) measured with PSNR, and MS-SSIM comparison against other video compression methods.

The encoder's compression ratio grows dynamically throughout the training process. The benefit of this aspect of the invention is that no matter what dataset input is, the model can achieve a superior compression ratio with meager losses in image quality and fidelity as compared to all known existing solutions.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A method for dynamic compression of video data, the method implemented on a system comprising a processor and a memory, the method comprising:
implementing a convolution neural network-based quantized auto-encoder network comprising:
an encoder network comprising one or more three-dimensional convolution compression blocks,
a bottleneck network comprising a fake quantization module, an MPEG encoder, and an MPEG decoder, and
a decoder network,
wherein the encoder network upon execution by the processor is configured to receive input video data and reduce dimensions of the input video data by dynamic processing using the one or more three-dimensional convolution compression blocks in series,
wherein the bottleneck network upon execution by the processor is configured to receive an unquantized compression representation of the input video data as an output of the encoder network,
wherein the decoder network upon execution by the processor is configured to receive a quantized compressed representation of the input video data as an output of the bottleneck network and restructure the quantized compressed representation to obtain compressed output video.

2. The method according to claim 1, wherein the one or more three-dimensional convolution compression blocks comprises a Conv3D filter and a three-dimensional exponential linear unit (ELU) filter connecting in series.

3. The method according to claim 1, wherein the encoder network has a theoretical compression ratio of (2×8\hat{ }n):1, wherein n is a number of the three-dimensional convolution compression blocks in the encoder network.

4. The method according to claim 3, wherein the decoder network comprises n layers of UpSampling3D layer, wherein n is the number of three-dimensional convolution compression blocks in the encoder network.

5. A system for dynamic compression of video data, the system comprising a processor and a memory, the system configured to implement a method comprising:
constructing a convolution neural network-based quantized auto-encoder network comprising:
an encoder network comprising one or more three-dimensional convolution compression blocks,
a bottleneck network comprising a fake quantization module, an MPEG encoder, and an MPEG decoder, and
a decoder network,
wherein the encoder network upon execution by the processor is configured to receive input video data and reduce dimensions of the input video data by dynamic processing using the one or more three-dimensional convolution compression blocks in series,
wherein the bottleneck network upon execution by the processor is configured to receive an unquantized compression representation of the input video data as an output of the encoder network,
wherein the decoder network upon execution by the processor is configured to receive a quantized compressed representation of the input video data as an output of the bottleneck network and restructure the quantized compressed representation to obtain compressed output video.

6. The system according to claim 5, wherein the compression blocks achieve a compression ratio of (2×8\hat{ }n):1.

7. The system according to claim 5, wherein the system maintains temporal coherence through three-dimensional convolution operations.

8. The system according to claim 7, wherein quality assessment utilizes PSNR and MS-SSIM for video quality evaluation.

9. A method for dynamic compression of video data, the method implemented within a system comprising a processor and a memory, wherein the memory comprises:
a convolution neural network-based quantized auto-encoder network configured to be processed by the processor, the convolution neural network-based quantized auto-encoder network comprising:
an encoder network comprising one or more three-dimensional convolution compression blocks,
a bottleneck network comprising a fake quantization module, an MPEG encoder, and an MPEG decoder, and
a decoder network,
wherein the method comprises:
reducing dimensions of an input video data by dynamic processing using the one or more three-dimensional convolution compression blocks in series to obtain an unquantized compression representation of the input video data;
processing, by the bottleneck network upon execution by the processor, the unquantized compression representation of the input video data to obtain a quantized compressed representation of the input video data; and
restructuring, by the decoder network, upon execution by the processor, the quantized compressed representation to obtain compressed output video.

10. The method according to claim 9, wherein the one or more three-dimensional convolution compression blocks comprise a Conv3D filter and a three-dimensional exponential linear unit (ELU) filter connecting in series.

11. The method according to claim 9, wherein the encoder network has a theoretical compression ratio of (2×8\hat{ }n):1, wherein n is a number of the three-dimensional convolution compression blocks in the encoder network.

12. The method according to claim 11, wherein the decoder network comprises n layers of UpSampling3D layer, wherein n is the number of three-dimensional convolution compression blocks in the encoder network
